(19) United States
(12) Patent Application Publication
(10) Pub. No.: US 2021/0362764 A1
(43) Pub. Date: Nov. 25, 2021

(54) BABY CARRIAGE WITH IMPROVED EASE OF USE

(71) Applicant: BRAN-NEW INTERNATIONAL, Seoul (KR)

(72) Inventor: Mijin KIM, Bucheon-Si (KR)

(73) Assignee: BRAN-NEW INTERNATIONAL

(21) Appl. No.: 17/371,237

(22) Filed: Jul. 9, 2021

(30) Foreign Application Priority Data
May 20, 2020 (KR) 10-2020-0060468

(51) Int. Cl. B62B 7/00; B62B 9/14

(52) U.S. Cl. CPC B62B 7/006; B62B 9/14

(57) ABSTRACT

Proposed is a baby carriage with improved ease of use in which the overall frame structure of the baby carriage is minimized while durability of the baby carriage is maintained, such that it is possible to easily couple a canopy in a state of being separable, it is possible to easily switch between an unfolding mode and a folding mode even in the state in which the canopy is not detached, it is possible to greatly reduce the overall size of the baby carriage in the folding mode, it is possible to easily adjust the angle of a seat back in the form of a chair, and in which a safety bar is located between legs of a baby in the baby carriage, and a tray is easily coupled in a state of being separable such that the baby can eat a light snack.

### BACKGROUND OF THE INVENTION

### Field of the Invention

The present invention relates to a baby carriage with improved ease of use in which the overall frame structure of the baby carriage is minimized while durability of the baby carriage is maintained, whereby it is possible to reduce production costs of the baby carriage, in that it is possible to easily switch between an unfolding mode and a folding mode of the baby carriage, in that it is possible to greatly reduce the overall size of the baby carriage in the folding mode, whereby it is possible to easily carry or store the baby carriage, in that a baby in the baby carriage feels stable and excellent ride comfort, and that the baby can comfortably rest depending on the state of use thereof.

### Description of the Related Art

A conventional baby carriage is manufactured such that a boarding space thereof is suitable for an infant, whereby the infant may get into the baby carriage while feeling excellent ride comfort. However, the baby carriage is relatively bulky and heavy. Even in a folded state, the volume of the baby carriage is large, whereby the baby carriage is not smoothly received in the trunk of a vehicle or occupies a major portion of the trunk at the time of outing. Furthermore, it is difficult to carry the baby carriage due to weight and size thereof.

In addition, an age group capable of using the conventional baby carriage is relatively small, whereby it is inconvenient for a child larger than an infant to get in the baby carriage due to a narrow boarding space thereof. As a result, the period of use of the baby carriage is relatively short.

In order to solve the above problems, a simple baby carriage configured to allow a baby to be seated like a chair has been developed. However, switching between an unfolding mode and a folding mode is complicated depending on the state of use thereof, and separation and coupling of a canopy are separately performed, which is inconvenient.

### PRIOR ART DOCUMENT

### Patent Document

(Patent Document 1) Korean Registered Patent No. 10-1894460 (2018 Aug. 28)

### SUMMARY OF THE INVENTION

The present invention has been made in view of the above problems, and it is an object of the present invention to provide a baby carriage with improved ease of use in which the overall frame structure of the baby carriage is minimized while durability of the baby carriage is maintained, whereby it is possible to reduce production costs of the baby carriage, in that it is possible to easily couple a canopy in a state of being separable, in that it is possible to easily switch between an unfolding mode and a folding mode even in the state in which the canopy is not detached, in that it is possible to greatly reduce the overall size of the baby carriage in the folding mode, whereby it is possible to easily carry or store the baby carriage, in that it is possible to easily adjust the angle of a seat back in the form of a chair, in that a safety bar is located between legs of a baby in the baby carriage, whereby it is possible to prevent the baby from falling forwards, and in that a tray is easily coupled in a state of being separable such that the baby can eat a light snack, as needed.

In accordance with the present invention, the above and other objects can be accomplished by the provision of a baby carriage with improved ease of use, the baby carriage including a main body frame configured to entirely support a body of the baby carriage and to be folded and unfolded through a hinge structure such that the shape of the main body frame can be changed, a chair type seat frame coupled to the upper end of the front of the main body frame, the seat frame being configured such that the outer circumference of the seat frame is covered with a seat sheet, and a carriage wheel unit including driving wheels coupled to the front of the lower end of the main body frame and to left and right sides of the rear of the main body frame in symmetry, the carriage wheel unit being configured to drive the baby carriage.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing the overall shape of a baby carriage with improved ease of use according to the present invention to which a tray is optionally coupled;

FIG. 2 is a perspective view showing the overall shape of the baby carriage with improved ease of use according to the present invention to which a horizontal bar is optionally coupled;

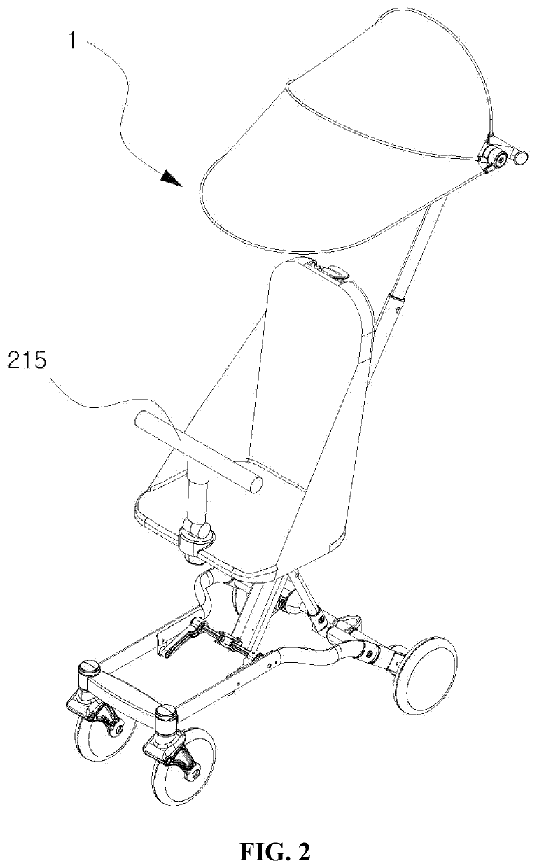

FIG. 3 is an exploded perspective view showing structural elements of the baby carriage with improved ease of use according to the present invention;

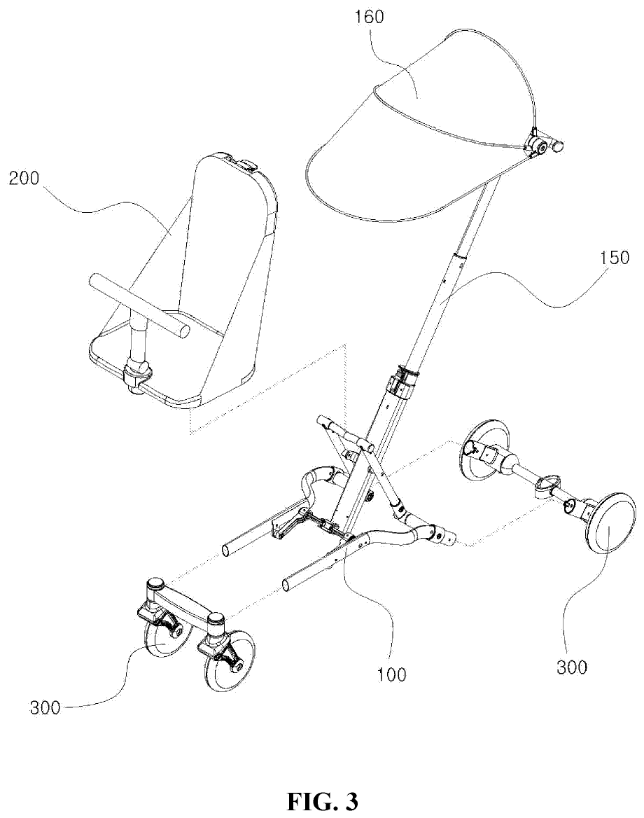

FIG. 4 is a perspective view showing the overall shape of a main frame according to the present invention and structural elements of the main frame;

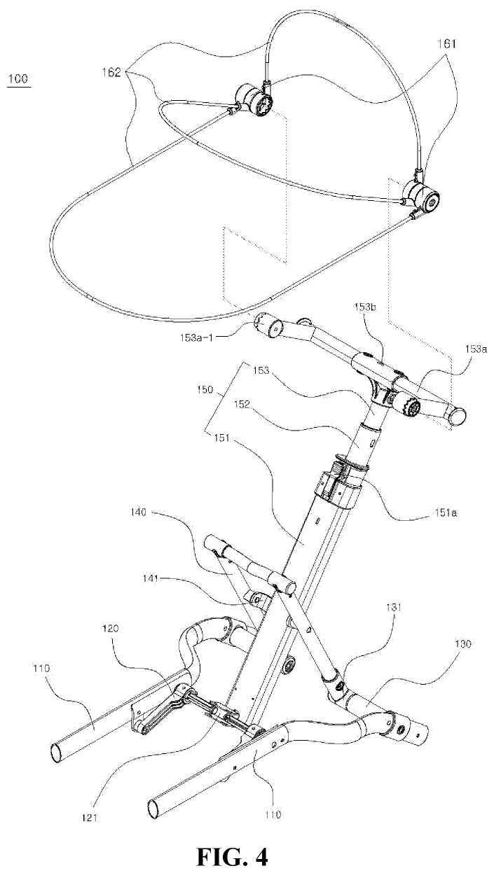

FIG. 5 is an exploded perspective view showing structural elements of a seat frame according to the present invention to which the tray is optionally coupled;

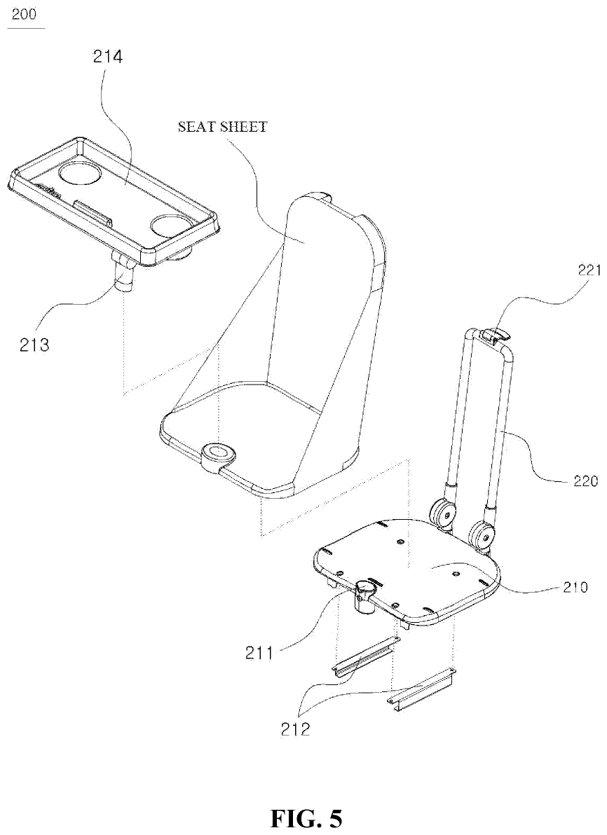

FIG. 6 is an exploded perspective view showing structural elements of the seat frame according to the present invention to which the horizontal bar is optionally coupled;

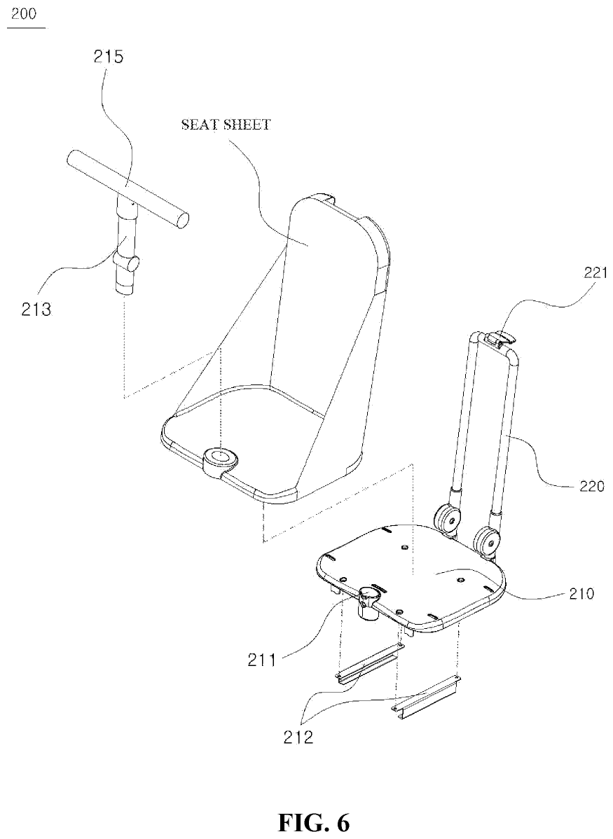

FIG. 7 is a partially enlarged view showing a coupling structure between the tray and a safety bar coupled to a hip support frame according to the present invention;

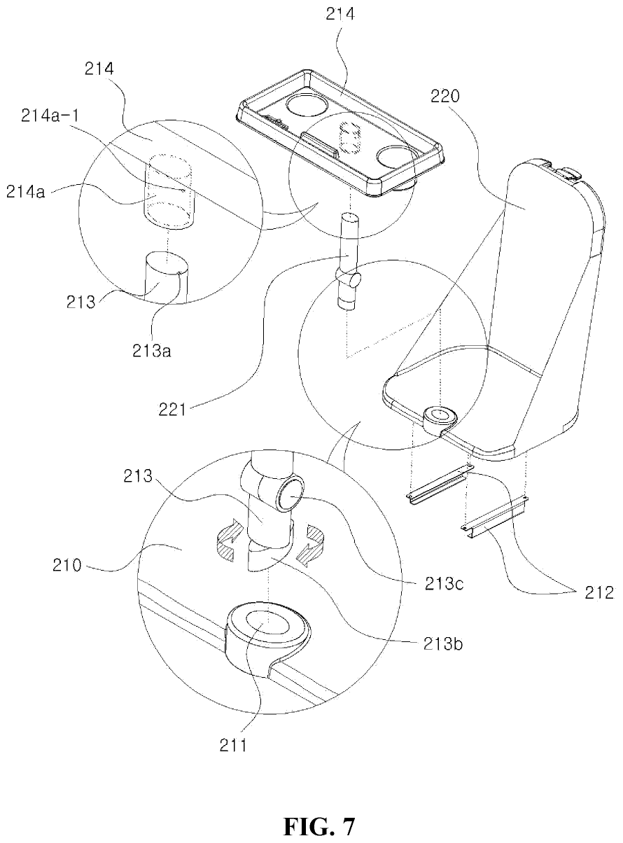

FIG. 8 is a partially enlarged view showing a coupling structure between the horizontal bar and the safety bar coupled to the hip support frame according to the present invention;

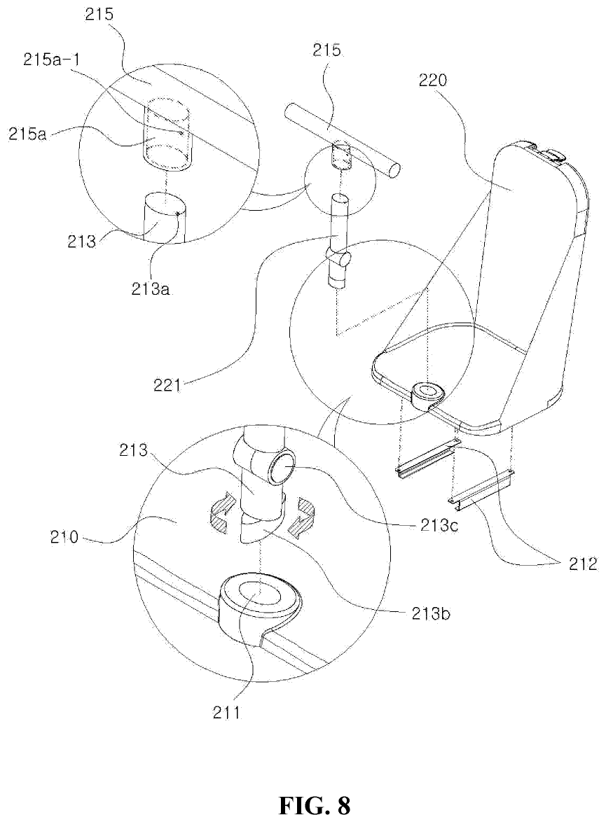

FIG. 9 is a perspective view showing structural elements of a canopy unit according to the present invention;

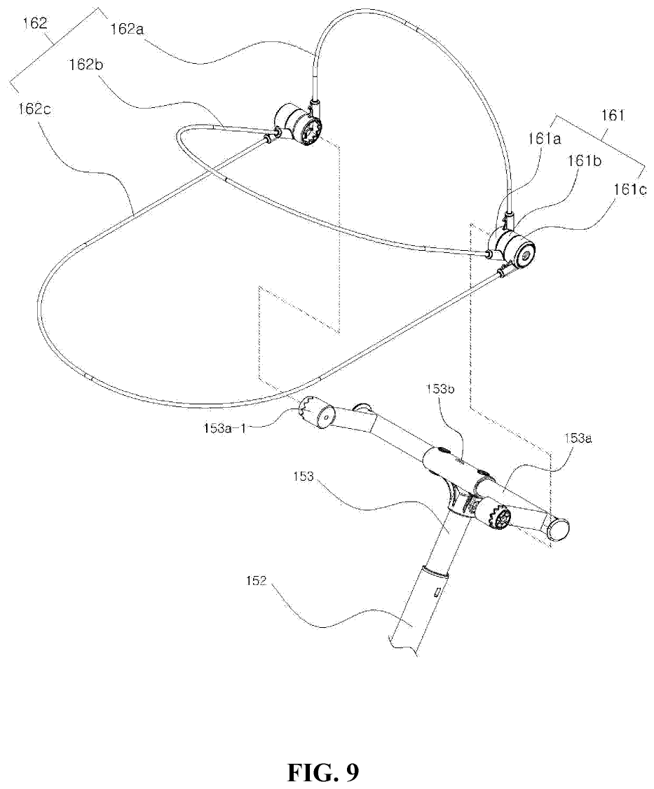

FIG. 10 is an exploded view of the structural elements of the canopy unit according to the present invention and a partially enlarged view showing inner circumferential triangular protrusions of a first canopy rotation portion engaged with outer circumferential triangular protrusions of a canopy detachment unit;

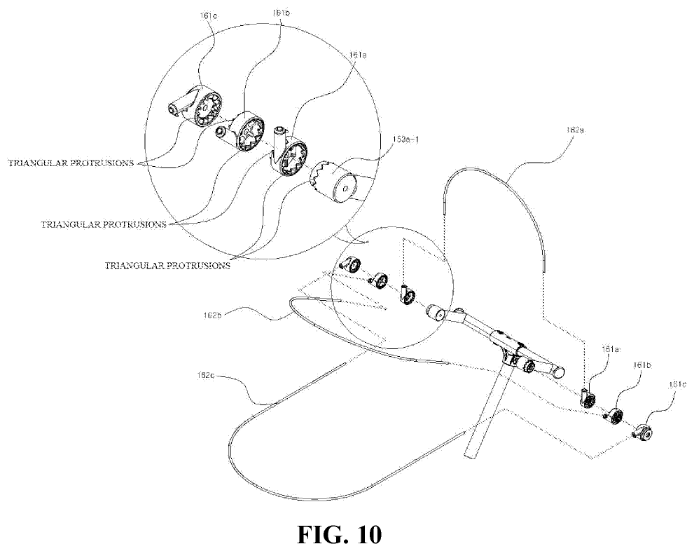

FIG. 11 is a view showing structural elements of a front wheel driving unit according to the present invention and a partially enlarged view showing a portion thereof;

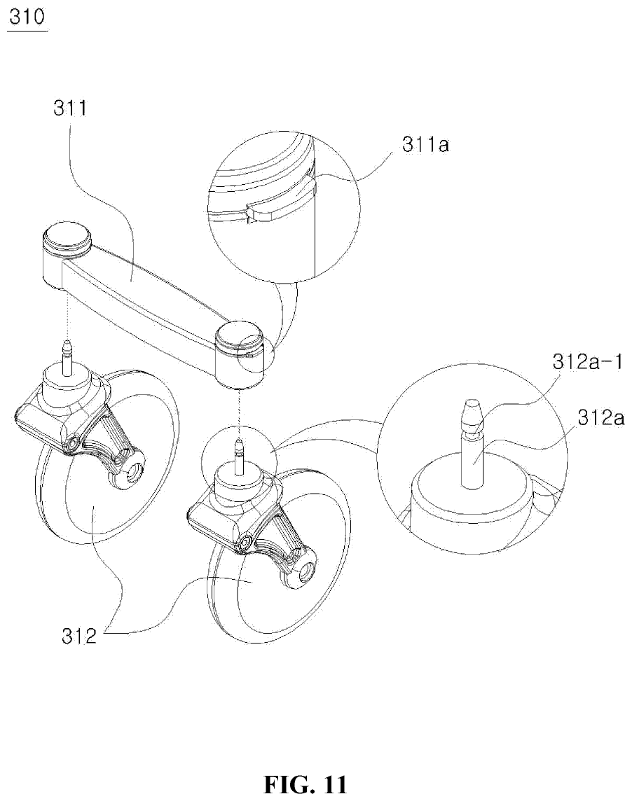

FIG. 12 is a view showing structural elements of a rear wheel driving unit according to the present invention and a partially enlarged view showing a portion thereof; and

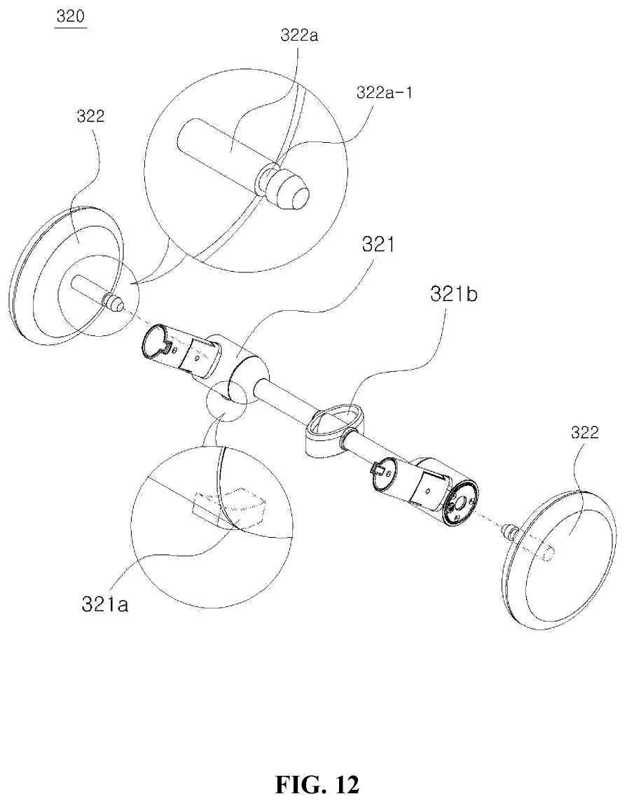

FIG. 13 is a side view sequentially showing a folding mode switching process of the baby carriage with improved ease of use according to the present invention.

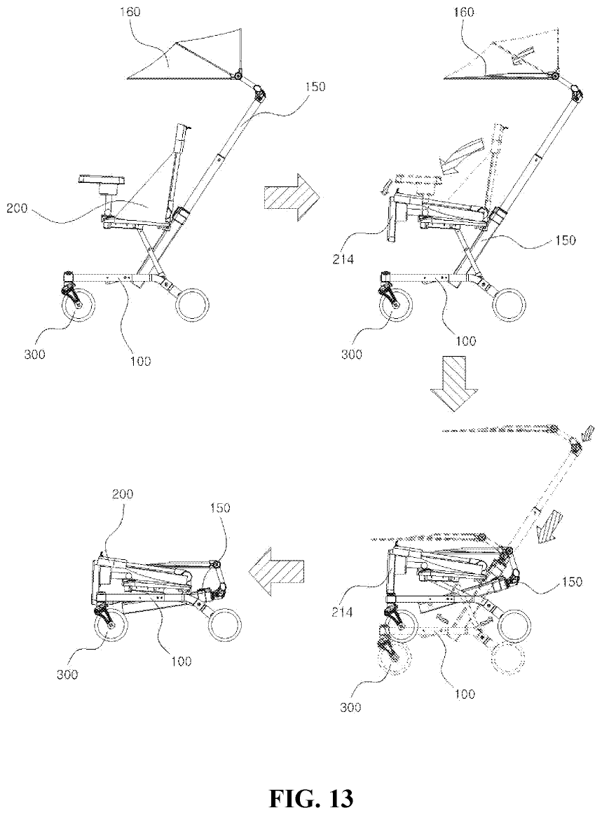

### DETAILED DESCRIPTION OF THE INVENTION

Hereinafter, preferred embodiments of the present invention will be described with reference to the accompanying drawings.

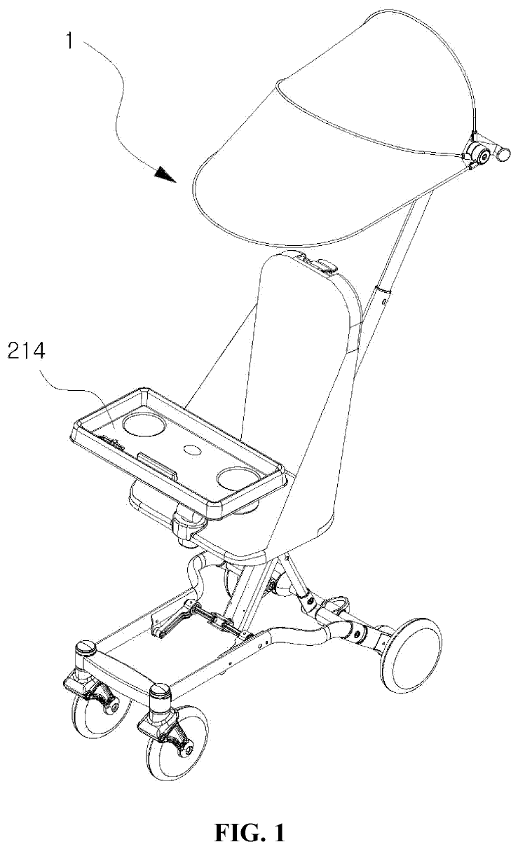

FIG. 1 is a perspective view showing the overall shape of a baby carriage with improved ease of use according to the present invention. The baby carriage includes a main body frame 100, a seat frame 200, and a carriage wheel unit 300.

First, the main body frame 100 according to the present invention will be described.

The main body frame 100 is configured to entirely support a body of the baby carriage and to be folded and unfolded through a hinge structure such that the shape of the main body frame 100 can be changed.

The main body frame 100 includes lower-end main frames 110, a lower-end front connection frame 120, lower-end rear support frames 130, a seat support frame 140, and a length-adjustable handle frame 150.

In addition, the main body frame 100 according to the present invention includes a canopy unit 160 configured to be detachably coupled thereto.

The lower-end main frames 110 are formed at the lower end of the main body frame 100 so as to be disposed in left-right symmetry. The front parts of the lower-end main frames 110 are formed so as to be parallel to each other in a horizontal state, and the rear parts of the lower-end main frames 110 are formed so as to be bent outwards.

A front-wheel driving unit of the carriage wheel unit 300 is coupled to the distal ends of the front parts of the lower-end main frames 110 so as to be supported thereby, and a rear-wheel driving unit of the carriage wheel unit 300 is coupled to the distal ends of the rear parts of the lower-end main frames 110 so as to be supported thereby. The lower-end front connection frame 120 is coupled to left and right insides of the front parts of the lower-end main frames 110 so as to be supported thereby, and the lower-end rear support frames 130 are coupled to left and right insides of the rear parts of the lower-end main frames 110 so as to be supported thereby.

The lower-end front connection frame 120 is a frame configured to connect the left and right insides of the front parts of the lower-end main frames 110 to each other so as to support the left and right insides of the front parts of the lower-end main frames 110. A first rotary shaft 121 configured to be rotated in an upward-downward direction based on a leftward-rightward longitudinal direction is formed at the middle of the rear part of the lower-end front connection frame 120 so as to be axially coupled to one side of the lower end of the length-adjustable handle frame 150 in order to support the length-adjustable handle frame 150.

The first rotary shaft 121 is a shaft formed at the middle of the rear part of the lower-end front connection frame 120 so as to be rotated in the upward-downward direction based on the leftward-rightward longitudinal direction. The first rotary shaft 121 is connected to the lower end of the length-adjustable handle frame 150 so as to primarily support the lower end of the length-adjustable handle frame 150 that is rotated when the baby carriage 1 is folded or unfolded.

The outer ends of the lower-end rear support frames 130 are coupled through the left and right insides of the rear parts of the lower-end main frames 110, and second rotary shafts 131 configured to be rotated in the upward-downward direction are formed at left and right inner ends of the lower-end rear support frames 130. The second rotary shafts 131 are identical in construction to each other. Each lower end of the seat support frame 140 is coupled to a recess formed in the circumference of a corresponding one of the second rotary shafts 131 so as to be supported thereby.

The second rotary shafts 131 are formed at the left and right inner ends of the lower-end rear support frames 130 so as to be disposed in symmetry. The second rotary shafts 131 are shafts configured to be rotated in the upward-downward direction based on the leftward-rightward longitudinal direction. The second rotary shafts 131 serve to rotate the seat support frame 140 inserted into one side of the circumference of each thereof.

The seat support frame 140 is a “[”-shaped bar frame. Left and right lower ends of the seat support frame 140 are inserted into the recesses formed in the circumferences of the second rotary shafts 131. A handle frame support portion 141 configured to support the rear surface of one side of the lower end of the length-adjustable handle frame 150 is formed between left and right frame portions of the seat support frame 140 formed so as to be parallel to each other. The handle frame support portion 141 is rotated simultaneously with rotation of the second rotary shafts 131, and serves to support the lower end of the seat frame 200 coupled to the upper end of the seat support frame 140.

The handle frame support portion 141 supports the rear surface of one side of the lower end of the seat support frame 140, and secondarily supports the rear surface of one side of the lower end of the length-adjustable handle frame 150 that is rotated when the baby carriage 1 is folded or unfolded.

The seat support frame 140 according to the present invention is configured such that left and right sides of the upper end of the seat support frame 140 protrude in the shape of a bar so as to be inserted into insides of rail frames 212 coupled to the lower end of a hip support frame 210. In a folding mode or an unfolding mode of the baby carriage 1, the seat support frame 140 is moved along rail recesses formed in the rail frames 212 in the forward-rearward direction so as to be folded or unfolded about the second rotary shafts 131.

The length-adjustable handle frame 150 is formed in the shape of a bar inclined rearwards and upwards. One side of the lower end of the length-adjustable handle frame 150 is coupled to the lower-end front connection frame 120, the rear surface of one side of the lower end of the length-adjustable handle frame 150 is supported by one side of the seat support frame 140, and a handle is formed at the rear upper end of the length-adjustable handle frame 150 so as to vary the length of the length-adjustable handle frame 150. The length-adjustable handle frame 150 includes a first length-adjustable frame 151, a second length-adjustable frame 152, and a third length-adjustable frame 153.

The first length-adjustable frame 151 is a frame formed in the shape of a rectangular bar inclined rearwards and upwards. The lower end of the first length-adjustable frame 151 is coupled to the lower-end front connection frame 120, one side of the lower end of the first length-adjustable frame 151 is coupled to one side of the seat support frame 140, and a first locking switch 151a is formed at the front surface of the upper end of the first length-adjustable frame 151. The first length-adjustable frame 151 serves to support the second length-adjustable frame 152 and the third length-adjustable frame 153, which are sequentially inserted thereinto inwards from above.

The first locking switch 151a is formed so as to have an elastic structure in which a protruding pin is formed at the inside of the first locking switch 151a so as to be detachably inserted into one of through holes formed in the upper and lower ends of one side of the second length-adjustable frame 152.

In the first locking switch 151a according to the present invention, the inside protruding pin is inserted into the through-hole formed in one side of the lower end of the second length-adjustable frame 152 to fix the second length-adjustable frame 152 in the state in which the second length-adjustable frame 152 protrudes upwards in a longitudinal direction in the unfolding mode of the baby carriage 1, and the inside protruding pin is inserted into the through-hole formed in one side of the upper end of the second length-adjustable frame 152 to fix the second length-adjustable frame 152 in the state in which the second length-adjustable frame 152 retreats downwards in the longitudinal direction in the folding mode of the baby carriage 1.

The second length-adjustable frame 152 is a hollow cylindrical frame inserted into the rear upper end of the first length-adjustable frame 151. The second length-adjustable frame 152 is fixed in a state of protruding upwards in the longitudinal direction of the first length-adjustable frame 151 or in a state of retreating downwards in the longitudinal direction of the first length-adjustable frame 151 in order to vary the length of the length-adjustable handle frame 150.

The third length-adjustable frame 153 is a hollow cylindrical frame inserted into the rear upper end of the second length-adjustable frame 152. A handle portion 153a formed so as to have the shape of handles extending in parallel to each other in the longitudinal direction while being disposed in left-right symmetry is formed at the upper end of the third length-adjustable frame 153. Canopy rotation fixing shafts 153a-1 are formed at the fronts of left and right ends of the handle portion 153a so as to be disposed in symmetry, and a second locking switch 153b is formed at one side of the middle of the handle portion 153a. The third length-adjustable frame 153 is fixed in a state of protruding upwards in the longitudinal direction of the second length-adjustable frame 152 or in a state of retreating downwards in the longitudinal direction of the second length-adjustable frame 152 in order to vary the length of the length-adjustable handle frame 150.

The canopy rotation fixing shafts 153a-1 are circular rotary shaft frames formed at the fronts of the left and right ends of the handle portion 153a in symmetry. Triangular protrusions are formed along the outer circumference of each circular rotary shaft at predetermined intervals, and an elastic spring having elastic force applied in the leftward-rightward direction is mounted in each circular rotary shaft. The canopy unit 160 is coupled to the canopy rotation fixing shafts 153a-1 in the leftward-rightward direction in a state of being capable of being rotated or fixed.

When the canopy unit 160 is coupled to the canopy rotation fixing shafts 153a-1 in the outward direction, the triangular protrusions formed along the outer circumference of each of the canopy rotation fixing shafts 153a-1 are fixed in a state of being engaged with a plurality of triangular protrusions formed along the inner circumference of a first canopy rotation portion 161a at predetermined intervals. When the first canopy rotation portion 161a is rotated, the triangular protrusions of the first canopy rotation portion 161a are disengaged from the triangular protrusions of the canopy rotation fixing shaft 153a-1, and the triangular protrusions of the canopy rotation fixing shaft 153a-1 and the triangular protrusions of the first canopy rotation portion 161a are engaged with each other by the elastic springs mounted in the canopy rotation fixing shafts 153a-1, whereby the canopy rotation fixing shaft 153a-1 and the first canopy rotation portion 161a are fixed to each other.

As a result, the first canopy rotation portion 161a coupled to the outer surface of the canopy rotation fixing shaft 153a-1 can be rotated or fixed.

The second locking switch 153b is formed so as to have an elastic structure in which a protruding pin connected via a wire is formed at the inside of the second locking switch 153b so as to be detachably inserted into a through hole formed in the inside of the second length-adjustable frame 152.

In the second locking switch 153b according to the present invention, the inside protruding pin is inserted into the through-hole formed in one side of the inner upper end of the second length-adjustable frame 152 to fix the third length-adjustable frame 153 in the state in which the third length-adjustable frame 153 protrudes upwards in the longitudinal direction in the unfolding mode of the baby carriage 1, and the inside protruding pin is inserted into the through-hole formed in one side of the inner lower end of the third length-adjustable frame 153 to fix the third length-adjustable frame 153 in the state in which the third length-adjustable frame 153 retreats downwards in the longitudinal direction in the folding mode of the baby carriage 1.

The canopy unit 160 is coupled to the outer surfaces of the canopy rotation fixing shafts 153a-1 formed at the fronts of the left and right sides of the upper end of the length-adjustable handle frame 150 in symmetry. The canopy unit 160 is coupled to the outsides of the canopy rotation fixing shafts 153a-1 so as to be rotatable such that a canopy sheet is unfolded. The canopy unit 160 includes canopy rotation units 161 and a canopy frame unit 162.

Each of the canopy rotation units 161 is configured such that a plurality of circular frames is sequentially axially coupled to the outer surface of a corresponding one of the left and right sides of the upper end of the length-adjustable handle frame 150. Left and right rear ends of canopy frames are sequentially coupled to outer insertion recesses formed in the sequentially coupled circular frames so as to be disposed in left-right symmetry such that the canopy frames can be rotated or fixed. Each of the canopy rotation units 161 includes a first canopy rotation portion 161a, a second canopy rotation portion 161b, and a third canopy rotation portion 161c.

The first canopy rotation portion 161a is formed in the shape of a cylinder coupled to the outer surface of the canopy rotation fixing shaft 153a-1 formed at a corresponding one of the left and right sides of the upper end of the length-adjustable handle frame 150. Inner circumferential triangular protrusions are formed along the circumference of a recess formed in the first canopy rotation portion 161a so as to be engaged with outer circumferential triangular protrusions of the canopy rotation fixing shaft 153a-1. Outer circumferential triangular protrusions are formed along the outer circumference of the first canopy rotation portion 161a so as to be engaged with inner circumferential triangular protrusions of the second canopy rotation portion 161b. A canopy frame insertion recess is formed in one side of the outer circumference of the first canopy rotation portion 161a so as to support a first canopy frame 162a in the state in which the first canopy rotation portion 161a is rotated or fixed.

The first canopy rotation portion 161a serves to entirely support the canopy unit 160, to set the fixing angle of the first canopy frame 162a depending on axial rotation thereof, and to axially support the second canopy rotation portion 161b.

The second canopy rotation portion 161b is formed in the shape of a cylinder coupled to the outside of the first canopy rotation portion 161a. Inner circumferential triangular protrusions are formed along the circumference of a recess formed in the second canopy rotation portion 161b so as to be engaged with the outer circumferential triangular protrusions of the first canopy rotation portion 161a. Outer circumferential triangular protrusions are formed along the outer circumference of the second canopy rotation portion 161b so as to be engaged with inner circumferential triangular protrusions of the third canopy rotation portion 161c. A canopy frame insertion recess is formed in one side of the outer circumference of the second canopy rotation portion 161b so as to support a second canopy frame 162b in the state in which the second canopy rotation portion 161b is rotated or fixed.

The second canopy rotation portion 161b serves to set the fixing angle of the second canopy frame 162b depending on axial rotation thereof and to axially support the third canopy rotation portion 161c.

The third canopy rotation portion 161c is formed in the shape of a cylinder coupled to the outside of the second canopy rotation portion 161b. Inner circumferential triangular protrusions are formed along the circumference of a recess formed in the third canopy rotation portion 161c so as to be engaged with the outer circumferential triangular protrusions of the second canopy rotation portion 161b. A canopy frame insertion recess is formed in one side of the outer circumference of the third canopy rotation portion 161c so as to support a third canopy frame 162c in the state in which the third canopy rotation portion 161c is rotated or fixed.

The third canopy rotation portion 161c serves to set the fixing angle of the third canopy frame 162c depending on axial rotation thereof.

The canopy rotation units 161 according to the present invention are disposed in left-right symmetry. Each of the canopy rotation units 161 is configured such that the first canopy rotation portion 161a, the second canopy rotation portion 161b, and the third canopy rotation portion 161c are sequentially coupled to each other from inside to outside so as to be rotated in an axial direction. The first canopy rotation portion 161a, the second canopy rotation portion 161b, and the third canopy rotation portion 161c are smoothly rotated in the axial direction and are then fixed, whereby the canopy frame unit 162 is smoothly switched between an unfolding mode and a folding mode.

The canopy frame unit 162 is configured such that bar type frames, each of which has left and right sides formed parallel to each other in symmetry and a round middle portion, are sequentially disposed in the order of size and are sequentially coupled to the canopy frame insertion recesses formed in the outer circumferences of the canopy rotation units 161 so as to be folded and unfolded in the shape of a fan as the result of rotation thereof.

In the canopy frame unit 162 according to the present invention, the canopy sheet is fixed outside the first canopy frame 162a, the second canopy frame 162b, and the third canopy frame 162c so as to be folded or unfolded in order to cover the upper end of the seat frame 200.

Specifically, when a caregiver pulls the third canopy frame 162c in a direction in which the canopy unit 160 is unfolded in the state in which the canopy unit 160 is folded, the third canopy rotation portion 161c coupled to the third canopy frame 162c, the second canopy rotation portion 161b coupled to the second canopy frame 162b, and the first canopy rotation portion 161a coupled to the first canopy frame 162a are sequentially rotated, whereby the canopy unit 160 is unfolded.

On the other hand, when the caregiver pushes the third canopy frame 162c in a direction in which the canopy unit 160 is folded in the state in which the canopy unit 160 is unfolded, the third canopy rotation portion 161c coupled to the third canopy frame 162c, the second canopy rotation portion 161b coupled to the second canopy frame 162b, and the first canopy rotation portion 161a coupled to the first canopy frame 162a are sequentially rotated, whereby the canopy unit 160 is folded.

As described above, an unfolding mode and a folding mode of the canopy unit 160 are easily achieved by pulling the third canopy frame 162c in the direction in which the canopy unit 160 is unfolded and by pushing the third canopy frame 162c in the direction in which the canopy unit 160 is folded. Consequently, it is possible to easily switch between the unfolding mode and the folding mode without separating the canopy unit 160 depending on the state of use of the baby carrier.

Next, the seat frame 200 according to the present invention will be described.

The seat frame 200 is a chair type frame coupled to the upper end of the front of the main body frame 100, and the outer circumference of the seat frame 200 is covered with a seat sheet.

The seat frame 200 includes a hip support frame 210 and a seat back frame 220.

The hip support frame 210 is a rectangular frame having rounded corners. An elliptical safety bar insertion hole 211 is formed vertically through the hip support frame 210 at one side of the middle of the front of the hip support frame 210. Rail frames 212, in each of which a rail recess is formed so as to extend in a forward-rearward direction, are formed at the left side and the right side of the lower surface of the hip support frame 210. The seat back frame 220 is fixed to the left and right sides of the rear of the hip support frame 210 by insertion.

A safety bar 213 is coupled to the hip support frame 210 according to the present invention, and a tray 214 or a horizontal bar 215 is optionally coupled to the upper end of the safety bar 213 in a state of being separable therefrom.

The safety bar 213 is an elliptical straight bar. An elastic push-type detachment pin 213a is formed on the middle of the upper end of the rear of the safety bar 213 in a protruding state. Rotary buttons 213b configured to be rotated about rotary shafts in the upward-downward direction are formed at the left and right sides of the lower part of the safety bar 213. A safety bar locking portion 213c configured to be rotated in a horizontal direction is formed at the lower end of the safety bar 213 so as to fix the safety bar 213 when being inserted through the safety bar insertion hole 211 formed in the hip support frame 210.

The detachment pin 213a is configured to be restored to the original state thereof by elastic force. The detachment pin 213a serves to fix the tray 214 when being inserted into a tray detachment recess 214a-1 formed in the lower end of the tray 214. The detachment pin 213a also serves to fix the horizontal bar 215 when being inserted into a horizontal bar detachment recess 215a-1 formed in the lower end of the horizontal bar 215.

The rotary buttons 213b are configured to be restored to the original states thereof by elastic force. The safety bar 213 is rotated forwards or rearwards based on the rotary buttons, whereby the volume of the baby carriage 1 may be reduced or a baby may get into and out of the baby carriage without difficulty.

The safety bar locking portion 213c is inserted through the safety bar insertion hole 211 formed in the hip support frame 210 and is then rotated by an angle of 90 degrees in the horizontal direction in order to fix the safety bar 213.

The tray 214 or the horizontal bar 215 is optionally coupled to the safety bar 213 in a state of being separable therefrom.

Specifically, a tray 214 having an insertion recess 214a formed in one side of the center of the lower end thereof so as to allow the upper end of the safety bar 213 to be inserted thereinto and a tray detachment recess 214a-1 formed in one side of the rear surface of the insertion recess 214a or a horizontal bar 215 having an insertion recess 215a formed in one side of the center of the lower end thereof so as to allow the upper end of the safety bar 213 to be inserted thereinto and a horizontal bar detachment recess 215a-1 formed in one side of the rear surface of the insertion recess 215a is optionally coupled to the safety bar 213 in a state of being separable therefrom.

In the case in which the baby in the baby carriage 1 eats food or a snack, plays with a toy, or watches a video through a smart terminal, therefore, the tray 214 can be coupled to the safety bar 213. In the case in which the baby is transported or sleeps in the baby carriage 1, on the other hand, the horizontal bar 215 can be coupled to the safety bar 213.

The seat back frame 220 is a “[”-shaped bar frame. The lower ends of left and right sides of the seat back frame 220 are coupled to the rear of the hip support frame 210 by insertion. A pulling type angle-adjustable handle 221 configured to be rotated in the upward-downward direction is provided at the middle of the upper end of the seat back frame 220 so as to vary and fix the angle of the seat back frame 220.

When the angle-adjustable handle 221 is pulled in the upward direction, the seat back frame 220 may be rotated about a rotary shaft formed at the lower end thereof. When the pulled state of the angle-adjustable handle 221 is released, the angle-adjustable handle 221 returns to the original position thereof due to elasticity to fix the seat back frame 220 so as to be no further rotated.

Consequently, it is possible to easily change the angle of the seat back frame 220 and then to fix the seat back frame 220 in response to the demand of the baby, whereby the baby in the baby carriage 1 may feel comfortable and switching between the unfolding mode and the folding mode may be easily performed.

Next, the carriage wheel unit 300 according to the present invention will be described.

The carriage wheel unit 300 includes driving wheels coupled to the front of the lower end of the main body frame 100 and to the left and right sides of the rear of the main body frame 100 in symmetry to drive the baby carriage 1.

The carriage wheel unit 300 includes a front-wheel driving unit 310 and a rear-wheel driving unit 320.

The front-wheel driving unit 310 is configured such that a front-wheel frame 311 is coupled to the fronts of the lower-end main frames 110 formed at the main body frame 100 in left-right symmetry and such that front wheels 312 are coupled to the lower ends of the left and right sides of the front-wheel frame 311.

Elastic detachment switches 311a are formed at one side of the left end and one side of the right end of the front-wheel frame 311 so as to detach the left and right front wheels 312 from the front-wheel frame 311.

The front wheels 312 are coupled to the lower ends of the left and right sides of the front-wheel frame 311 in symmetry. A suspension configured to absorb shock in the upward-downward direction is mounted inside each of the front wheels 312.

In addition, a circular detachment bar 312a is formed at the upper end of each of the front wheels 312 so as to extend in the vertical direction, and a detachment recess 312a-1 is formed in one side of the upper end of the detachment bar 312a.

When the detachment switches 311a of the front-wheel frame 311 are pushed, pins coupled to the interiors of the detachment switches 311a are separated from the detachment recesses 312a-1, whereby the front wheels 312 are detached from the front-wheel frame 311. When the detachment bars 312a of the front wheels 312 are inserted into recesses formed in the lower ends of the left and right sides of the front-wheel frame 311, the pins coupled to the interiors of the elastic detachment switches 311a are inserted into the detachment recesses 312a-1 by elastic restoring force, whereby the front wheels 312 are coupled to the front-wheel frame 311.

The rear-wheel driving unit 320 is configured such that a rear-wheel frame 321 is coupled to the rears of the lower-end main frames 110 formed at the main body frame 100 in left-right symmetry and such that rear wheels 322 are coupled to the left and right sides of the rear-wheel frame 321.

Elastic detachment switches 322a are formed at one side of the left lower end and one side of the right lower end of the rear-wheel frame 321 so as to detach the left and right rear wheels 322 from the rear-wheel frame 321.

The right rear wheels 322 are coupled to the centers of the left and right sides of the rear-wheel frame 321 in symmetry.

In addition, a circular detachment bar 322a is formed at the center of the inside of each of the rear wheels 322 so as to extend in the vertical direction, and a detachment recess 322a-1 is formed in one side of the inner end of the detachment bar 322a.

When the detachment switches 321a of the rear-wheel frame 321 are pushed, pins coupled to the interiors of the detachment switches 321a are separated from the detachment recesses 322a-1, whereby the rear wheels 322 are detached from the rear-wheel frame 321. When the detachment bars 322a of the rear wheels 322 are inserted into recesses formed in the left and right sides of the rear-wheel frame 321, the pins coupled to the interiors of the elastic detachment switches 321a are inserted into the detachment recesses 322a-1 by elastic restoring force, whereby the rear wheels 322 are coupled to the rear-wheel frame 321.

In the present invention, as described above, the front wheels 312 and the rear wheels 322 may be individually detached, whereby it is possible to minimize the overall volume of the baby carriage 1 when not in use due to storage and carrying thereof, and therefore it is possible to improve space utilization.

Hereinafter, the operation of the baby carriage with improved ease of use according to the present invention will be described.

First, in order to switch to the unfolding mode of the baby carriage, the first locking switch and the second locking switch of the length-adjustable handle frame are pushed to protrude the second length-adjustable frame and the third length-adjustable frame rearwards and upwards from the first length-adjustable frame, and then the second length-adjustable frame and the third length-adjustable frame are fixed.

When the length-adjustable handle frame is pushed forwards, the first rotary shaft and the second rotary shafts are rotated, whereby the first length-adjustable frame and the seat support frame are erected and fixed in an intersecting state.

Subsequently, the angle-adjustable handle formed at the upper end of the seat back frame is pulled to erect the seat back frame in a folded state.

Subsequently, the lower end of the safety bar is inserted into the safety bar insertion hole formed in the hip support frame, the safety bar locking portion extending through the safety bar insertion hole is rotated in the horizontal direction to fix the safety bar, and the rotary buttons are pushed to erect the safety bar.

Subsequently, the tray or the horizontal bar is coupled to the upper end of the safety bar, as needed.

At this time, the detachment pin formed at the upper end of the rear of the safety bar is optionally inserted into the tray detachment recess or the horizontal bar detachment recess, whereby the safety bar is stably fixed.

Subsequently, the third canopy frame of the canopy unit coupled to the canopy rotation fixing shafts formed at the upper end of the length-adjustable handle frame is pulled in an unfolding direction such that the third canopy frame, the second canopy frame, and the first canopy frame are sequentially unfolded, whereby installation of the canopy unit is completed.

When use of the baby carriage is completed, the folding mode, which is opposite to the unfolding mode, can be executed in order to fold the baby carriage, and then the baby carriage can be stored.

As is apparent from the above description, the present invention has effects in that the overall frame structure of the baby carriage is simplified while durability of the baby carriage is maintained, whereby it is possible to reduce production costs of the baby carriage, in that it is possible to easily couple the canopy in a state of being separable, in that it is possible to easily switch between the unfolding mode and the folding mode even in the state in which the canopy is not detached, in that it is possible to greatly reduce the overall size of the baby carriage in the folding mode, whereby it is possible to easily carry or store the baby carriage, in that it is possible to easily adjust the angle of the seat back in the form of a chair, in that the safety bar is located between legs of a baby in the baby carriage, whereby it is possible to prevent the baby from falling forwards, and in that the tray is easily coupled in a state of being separable such that the baby can eat a light snack, as needed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A baby carriage comprising:
a main body frame configured to support a body of the baby carriage and to be folded and unfolded through a hinge structure such that a shape of the main body frame is changed;
a seat frame coupled to an upper end of a front of the main body frame, the seat frame being configured such that an outer circumference of the seat frame is covered with a seat sheet; and
a carriage wheel unit including driving wheels coupled to a front of a lower end of the main body frame and to left and right sides of a rear of the main body frame in symmetry, the carriage wheel unit being configured to drive the baby carriage,
the seat frame including:
a rectangular hip support frame having rounded corners, an elliptical safety bar insertion hole disposed vertically through the hip support frame at an edge of a middle of a front of the hip support frame, rail frames disposed at a left side and a right side of a lower surface of the hip support frame, each of the rail frames having a rail recess extending in a forward-rearward direction, and a seat back frame fixed to left and right sides of a rear of the hip support frame by insertion,
wherein the seat back frame is configured such that lower ends of left and right sides of the seat back frame are coupled to the rear of the hip support frame by insertion and such that a pullable angle-adjustable handle configured to be rotated in an upward-downward direction is disposed at a middle of an upper end of the seat back frame so as to adjust an angle of the seat back frame;
a safety bar coupled to the hip support frame, and having a shape of an elliptical straight bar, an elastic pushable detachment pin positioned on a middle of an upper end of a rear of the safety bar in a protruding state, rotary buttons configured to be rotated about rotary shafts in the upward-downward direction and disposed at left and right sides of a lower part of the safety bar, and a safety bar locking portion configured to be rotated in a horizontal direction and disposed at a lower end of the safety bar so as to fix the safety bar when being inserted through the safety bar insertion hole disposed in the hip support frame; and
a tray having an insertion recess disposed in one side of a center of a lower end thereof so as to allow the upper end of the safety bar to be inserted thereinto and a tray detachment recess disposed in one side of a rear surface of the insertion recess, or a horizontal bar having an insertion recess disposed in one side of a center of a lower end thereof so as to allow the upper end of the safety bar to be inserted thereinto and a horizontal bar detachment recess disposed in one side of a rear surface of the horizontal bar insertion recess,
wherein the tray or the horizontal bar is optionally coupled to the safety bar in a state of being separable therefrom.
